(19) United States
(12) Patent Application Publication
(10) Pub. No.: US 2011/0279281 A1
(43) Pub. Date: Nov. 17, 2011

(54) LAUNDRY MACHINE

(76) Inventors: Jong Hye Han, Gyeongsangnam-do (KR); In Haeng Cho, Gyeongsangnam-do (KR); Hoi Jin Jeong, Gyeongsangnam-do (KR)

(21) Appl. No.: 13/145,973

(22) PCT Filed: Jan. 22, 2010
(86) PCT No.: PCT/KR10/00413

§ 371 Date: Jul. 22, 2011

(30) Foreign Application Priority Data
Jan. 23, 2009 (KR) 10-2009-0005988

(51) Int. Cl. G08B 21/00

(52) U.S. Cl. 340/679

(57) ABSTRACT

The present invention relates to a laundry machine and a method for controlling the same.

The laundry machine includes a control panel having a main selection unit for selecting one from a plurality of washing courses, one or more than one sub-selection units for adjusting step conditions in one or more than one course selected by the main selection unit thus, and a plurality of light emission units for illuminating the main selection unit and the sub-selection unit selectively, and a control unit for driving the laundry machine according to the course and the step conditions selected thus, and controlling to illuminate the main selection unit and the sub-selection units in succession according to a handle order, thereby permitting the user to handle the laundry machine, easily.

### TECHNICAL FIELD

The present invention relates to a laundry machine and a method for controlling the same, and more particularly, to a laundry machine and a method for controlling the same which enables a user to operate easily.

### BACKGROUND ART

Generally, in the laundry machines, there are washing machines which wash washing objects, washing and drying machines which include drying functions, and dryers only for drying. By handling a selection unit, a user can select various courses of the laundry machine.

### DISCLOSURE OF INVENTION

### Technical Problem

However, if the user fails to handle the selection unit exactly, the user can not operate the laundry machine as intended.

### Technical Solution

To solve the problems, an object of the present invention is to provide a laundry machine and a method for controlling the same which enables easy handling of the laundry machine by a user.

To achieve these objects and other advantages and in accordance with the purpose of the invention, as embodied and broadly described herein, a laundry machine includes a control panel having a main selection unit for selecting one from a plurality of washing courses, one or more than one sub-selection units for adjusting step conditions in one or more than one course selected by the main selection unit thus, and a plurality of light emission units for illuminating the main selection unit and the sub-selection unit selectively, and a control unit for driving the laundry machine according to the course and the step conditions selected thus, and controlling to illuminate the main selection unit and the sub-selection units in succession according to a handle order.

In this instance, the light emission unit can include an LED provided to a back side of each of the main selection unit and the sub-selection units.

In the meantime, the control unit can control the light emission unit for illuminating the main selection unit when the laundry machine is turned on, and in this case, in a case the main selection unit is illuminated, the control unit can turn on the light emission unit for a preset time period or can turn on/off the light emission unit repeatedly in fixed intervals. And, in a case the main selection unit is illuminated, the control unit can activate only the main selection unit while leaving the sub-selection units inactivated.

Moreover, the control unit can control such that, after the main selection unit is selected, the sub-selection units corresponding to a washing step, a rinsing step, and a spinning step or drying step included to the course selected thus are illuminated according to a handling order. In this case, the light emission unit of the main selection unit can be turned off if the sub-selection unit is illuminated. In detail, if the sub-selection unit is illuminated, the control unit can control such that the light emission unit of the sub-selection unit of which selection is finished is turned off and the light emission unit of the sub-selection unit of the next step is turned on. In this instance, it is preferable that the control unit activates only sub-selection unit which is illuminated, while leaving the sub-selection units which are not illuminated inactivated. In the meantime, in a case the sub-selection unit is illuminated, the control unit can turn on the light emission unit for a preset time period or turn on/off the light emission unit repeatedly in fixed intervals.

In the meantime, if the sub-selection unit illuminated by the light emission unit is not selected for a preset time period, the control unit can turn off the light emission unit and turn on the sub-selection unit of the next step.

In the meantime, the main selection unit can include at least one steam course for supplying steam during operation of the laundry machine, and the sub-selection unit can further include a steam selection unit for controlling at least one condition of the steam supply. In this instance, the steam selection unit can include a steam supply time selection unit or a steam supply amount selection unit for controlling a steam supply time or a steam supply amount. In detail, if the steam course is selected at the main selection unit, the steam selection unit can be illuminated at first or last of the illumination of the sub-selection units. And, the control unit can activate the steam selection unit which is illuminated during illumination of the steam selection unit, and while leaving the sub-selection units which are not illuminated.

In another aspect of the present invention, a method for controlling a laundry machine includes the steps of illuminating a main selection unit which can select one of a plurality of washing courses, and illuminating one or more than one sub-selection unit which can change step conditions in one or more than one steps of the course selected at the main selection unit according to a handling order.

In this instance, the method can further include the step of turning on the laundry machine before the step of illuminating the main selection unit.

In the meantime, in a case the main selection unit is illuminated, a light emission unit can be turned on for a preset time period or turned on/off the light emission unit repeatedly in fixed intervals.

The step of illuminating one or more than one sub-selection unit can include the step of illuminating the sub-selection unit according to a washing step, a rinsing step, a spinning step or a drying step included to a course selected at the main selection unit. In this case, the step of illuminating one or more than one sub-selection unit includes the step of turning off the main selection unit. And, the step of illuminating one or more than one sub-selection unit can include the step of turning off the sub-selection unit of which selection is finished, and illuminating the sub-selection unit of the next step.

In this instance, it is preferable that only the sub-selection unit which is illuminated is activated, and the sub-selection unit which is not illuminated is inactivated. Moreover, in a case the sub-selection unit is illuminated, the light emission unit is turned on for a preset time period or turned on/off repeatedly in fixed intervals.

Furthermore, in a case the sub-selection unit which is illuminated is not selected for a preset time period, the sub-selection unit is turned off and the sub-selection unit of the next step is illuminated.

### Advantageous Effects

The present invention has following advantageous effects.

By illuminating the sub-selection units according to a handling order, the laundry machine permits the user to handle the sub-selection unit easily by enabling the user to handle the sub-selection units exactly according to an order.

### BRIEF DESCRIPTION OF THE DRAWINGS

FIG. 1 illustrates a perspective view of a laundry machine in accordance with a preferred embodiment of the present invention,

FIG. 2 illustrates a front view of the control panel on the laundry machine in FIG. 1,

FIG. 3 illustrates a perspective view of the semi-shielding member on the control panel in FIG. 1,

FIG. 4 illustrates a perspective view of a laundry machine in accordance with another preferred embodiment of the present invention,

FIG. 5 illustrates a longitudinal section of FIG. 4, and

FIG. 6 illustrates a front view of the control panel on the laundry machine in FIG. 4.

### BEST MODE

Reference will now be made in detail to the specific embodiments of the present invention, examples of which are illustrated in the accompanying drawings.

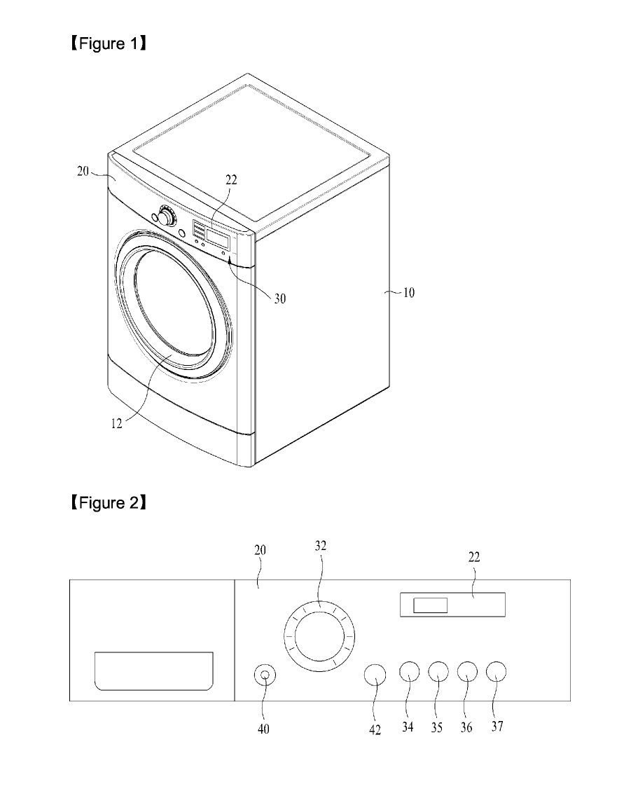

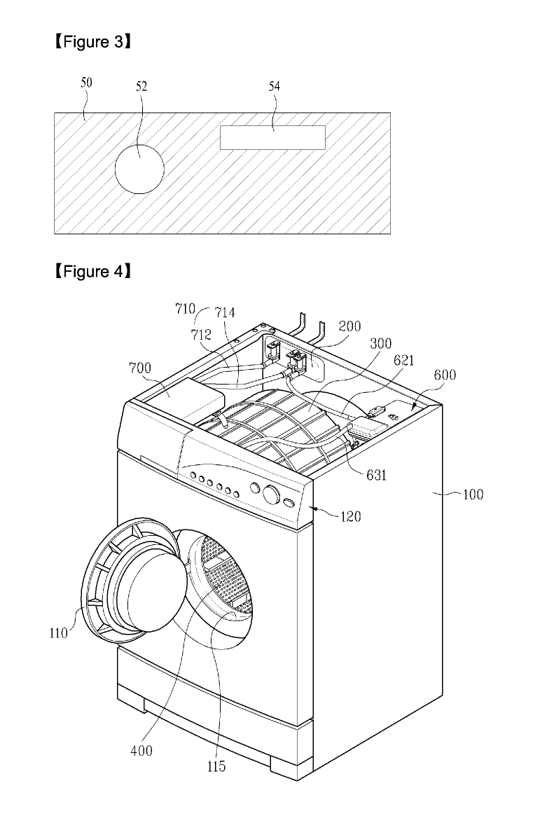

FIG. 1 illustrates a perspective view of a laundry machine in accordance with a preferred embodiment of the present invention. The word of laundry machine used in the specification is used to mean to include all of the washing machines which perform washing only, washing and drying machines which perform washing and drying, and dryers only for performing drying.

Referring to FIG. 1, the laundry machine includes a cabinet 10 which forms an exterior, and the cabinet 10 may include a door 12 in one side for introducing washing object to an inside thereof. The laundry machine may also include a drum (not shown) rotatably mounted in the cabinet 10 for holding the washing object. In the meantime, if the laundry machine is a washing machine, the laundry machine may have the drum rotatably mounted in the cabinet and may further include a tub (not shown) for holding washing water.

In the meantime, a control panel may be provided to a front of the laundry machine for controlling operation of the laundry machine.

FIG. 2 illustrates a front view of the control panel 20 on the laundry machine in FIG. 1.

Referring to FIG. 2, on one side the control panel 20, the laundry machine includes a selection unit 30 for enabling a user to select courses of the laundry machine, and a display unit 22 for displaying washing information during operation of the laundry machine.

The selection unit 30 includes a main selection unit 32 for selecting a plurality of washing courses, and one or more than one sub-selection units 34, 35, 36, and 37 for enabling to change a condition of a step of one or more than one steps in a course selected at the main selection unit 32. For an example, the main selection unit 32 may have a standard course, a bedquilt course, a baby clothes course, undergarment course, and a steam course. Each of the courses can include at least one of a washing step, a rinsing step, a spinning step, and a drying step, and the laundry machine is operated according to the selected courses. The main selection unit 32 may be of a button type, but preferably of a rotary type for the user to rotate the main selection unit 32 for selection of the course the user desires.

In the meantime, in a case the user selects a course at the main selection unit 32, step conditions can be stored in a control unit (not shown) set as defaults in advance according to steps of the selected course. For an example, in a case the standard course is selected, conditions on a water temperature and an amount of the water in a washing step, a number of rinsing and a rinsing time period in a rinsing step, a spinning rotation speed rpm in a spinning step, a drying time period in a drying step and so on can be stored in the control unit in advance for progressing washing according to the conditions stored thus.

In the meantime, though the conditions in each step can be stored in the control unit in advance, the conditions in each step can be changed by user's selection. That is, by handling the sub-selection units 34, 35, 36, and 37, the user can change the conditions of each step. Therefore, one or more than one of the sub-selection units 34, 35, 36, and 37 can be provided to each step of a selected course. Though FIG. 2 illustrates that four sub-selection units 34, 35, 36, and 37 are provided for the washing, rinsing, spinning and drying steps, it is apparent that a number of the sub-selection units are not limited to this, but more number of the sub-selection units can be included.

In the meantime, the control panel 20 may have a power button 40 for turn on/off the power of the laundry machine, and a start button 42 for applying a driving order to drive the selected course. The user can turn on/off the power of the laundry machine, and can drive the laundry machine by using the start button 42 after making selection by using the main selection unit 32 and/or the sub-selection units 34, 35, 36, and 37.

In the control panel 20 having above configuration, after selecting a desired course with the main selection unit 32 at first, the user progresses the selected course, either according to the step conditions set in advance in defaults or by handling the step conditions by using the sub-selection units 34, 35, 36, and 37. In the meantime, as described before, in a case, after selecting a desired course with the main selection unit 32, the user handles the step conditions by using the sub-selection units 34, 35, 36, and 37, it is convenient for the user to handle the step conditions according to a fixed order, preferably handling the step conditions according to steps of washing order. However, since the related art laundry machine fails to provide a separate configuration, or devices which guides the user to a selection order of the sub-selection units in handling the sub-selection units after selection of the main course, the related art laundry machine has inconvenience in that the user is required to handle the sub-selection units one by one.

Consequently, the laundry machine in accordance with a preferred embodiment of the present invention is provided with a configuration that guides the user to a handling order in a case the user handles the main selection unit and the sub-selection units, which will be described in detail with reference to the drawings.

Referring to FIG. 2, though not shown on the drawing, a plurality of light emission units can be provided on a back side of the main selection unit 32 and sub-selection units 34, 35, 36, and 37 for illuminating the selection units. The light emission units can be embodied in various types, for an example, in LED. The LED type light emission units has LEDs on a back side of each of the selection units, and a guide unit for making a light from the LED to be directed to each of the selection units. Moreover, in order to make the user to recognize the lights from the light emission units, at least a portion of each of the selection units is formed of a transparent material for transmission of the lights.

In the meantime, the control unit of the laundry machine controls to operate the laundry machine according to the course and the step conditions selected by using the main selection unit and the sub-selection units, and the light emission units which illuminate the main selection unit and the sub-selection units, which will be described in detail.

After introducing washing objects into the drum, the user turns on the power by handling the power button 40. According to this, the power is turned on for the laundry machine, to make the control unit at the selection unit 30 to turn on the light emission unit for illuminating the main selection unit 32. According to this, the user becomes to know that it is an order to handle the main selection unit 32, and handles the main selection unit 32 to select a desired course. In this case, for illuminating the main selection unit 32, the control unit of the laundry machine can turn on the light emission unit for the main selection unit 32 for a preset time period or turn on/off repeatedly in preset intervals.

In the meantime, in a case the main selection unit 32 is turned on, only the main selection unit 32 can be activated, while leaving rest of the selection unit, i.e., the sub-selection unit 34 to maintain inactivated state. The word of “activation” is a state in which changed course information or step conditions can be applied to the control unit by the user's handling of the selection unit, and the word of “inactivation” is a state in which the course information or step conditions can not be applied to the control unit even if the user handles the selection unit. Because it is preferable that the step conditions are changed by handling the sub-selection unit 34 after a course is selected by handling the main selection unit 32.

Then, the user may progresses the selected course according to step conditions of, for an example, the steps of washing, rinsing, spinning, and drying stored in defaults at the control unit or by changing one or more than one step conditions of the selected course. At first, if it is intended to progresses the selected course according to step conditions stored in defaults, after selecting a course by using the main selection unit 32, the washing can be progressed simply by handling the start button 42. Cases when the washing is progressed by user's change of the step conditions of each of the steps will be described.

Once the user handles the main selection unit 32 to select a desired course, the control unit in accordance with a preferred embodiment of the present invention illuminates the sub-selection units 34, 35, 36, and 37 according to a handling order, for the user to change the step conditions in each of the steps. In this instance, though the ‘handling order’ can be embodied in a variety of forms, preferably the handling order follows a washing order. In this case, the light emission unit of the main selection unit 32 of which selection is finished thus is turned off, making the user recognize that the main selection unit 32 is not object of selection.

As described before, the sub-selection units 34, 35, 36, and 37 are provided to be able to change one or more than one step conditions of, for an example, the steps of washing, rinsing, spinning, or drying. FIG. 2 illustrates that the laundry machine is provided with four sub-selection units 34, 35, 36, and 37, as an example. As an example, the sub-selection units 34, 35, 36, and 37 may be provided to handle, starting from a left side, a water temperature and an amount of the water in the washing step, a number of rinsing in the rinsing step, a spinning speed in the spinning step, or a drying time period in the drying step.

In the meantime, though most of the courses include the washing step, the rinsing step, the spinning step, only some of the steps can be included, or moreover, in addition to the steps, the drying step may be provided further. However, an order of general steps proceeds to the drying step through the washing step, the rinsing step, and the spinning step. Therefore, if the user intends to handle the step conditions in at least one of the steps of the course the user selected, it is preferable that the handling order follows the washing order.

That is, after the light emission unit of the main selection unit 32 is turned off, the control unit illuminates the sub-selection unit 34 of the washing step according to the handling order. According to this, the user recognizes that the conditions of the washing step can be handled, and, if desires, by handling the sub-selection unit 34 of the washing step, step conditions of the washing step, for an example, the water temperature, or the amount of the water are handled. And, in a case the sub-selection unit 34 is illuminated, the control unit of the laundry machine can turn on the light emission unit of the sub-selection unit 34 for a preset time period, or turn on/off repeatedly in preset intervals.

In the meantime, in a case the sub-selection unit 34 of the washing step is turned on, it is preferable that only the sub-selection unit 34 turned on thus is activated, while leaving rest of the sub-selection units 35, 36, and 37 to maintain an inactivated state. And, in this case, though the main selection unit 32 is not illuminated to maintain a deactivated state, the main selection unit 32 may be kept activated. This is because there can be a case when the user intends to change the course of the main selection unit 32 again in the handling step of the sub-selection unit after the user selects a course by using the main selection unit 32.

If the user handles the sub-selection unit 34 of the washing step following the illumination of the sub-selection unit 34 of the washing step, the control unit turns on a successive step, for an example, the sub-selection unit 35 of the rinsing step. In this case, the light emission unit of the sub-selection unit 34 of the washing step is turned off. In the meantime, in the case the sub-selection unit 34 of the washing step is illuminated, if the user does not handle the sub-selection unit 34 of the washing step for a preset time period, determining that the user has no intention to change conditions of the step, the control unit proceeds to the next step.

That is, the control unit becomes to turn of the emission unit of the sub-selection unit 35 of the rinsing step. In this instance, the keep turning on or turning on/off at preset intervals of the emission unit of the sub-selection unit 35 of the rinsing step is identical to the description made before. The activation of only the sub-selection unit 35 is activated while leaving rest of the sub-selection units inactivated when the sub-selection unit 35 of the rinsing step is illuminated is identical to the description made before, of which repetitive description will be omitted.

Since illumination of the sub-selection unit 36 of the spinning step or the sub-selection unit 37 of the drying step is similar to the description made before, no repetitive description will be made.

In the meantime, if the user intends to change a previous step condition in a step of selecting the sub-selection units 34, 35, 36, and 37 after selection of a course by using the main selection unit 32, for an example, in a case the sub-selection unit 36 of the spinning step is illuminated, there is a case when the user intends to change conditions of the washing step. In this case, the user can handle the main selection unit 32 again to select a desired course, in a case the user handles the main selection unit 32 in a step of selecting the sub-selection units 34, 35, 36, and 37 thus, the step conditions the user has changed are reset, enabling the user to handle the step conditions stored in defaults starting from the washing step.

After the user applies a desired course and/or step conditions through the steps described above, the user handles the start button 42 to start the laundry machine, and the control unit operates the laundry machine according to the selected course and/or selected step conditions.

In the meantime, even if the selection units are illuminated according to the handling order by above configuration and methods, in a case surroundings of the laundry machine is bright excessively like a day time, it may not be easy to identify an illuminated selection unit and non-illuminated selection units. In order to solve such a problem, the present invention provides a configuration which enables easy identification of the illuminated selection unit, which will be described with reference to the drawing.

FIG. 4 illustrates the semi-shielding member 50 mounted to a front of the control panel 20 of the laundry machine described before.

Referring to FIG. 4, the semi-shielding member 50 is provided to cover at least a portion of a front of the control panel 20, preferably, one side of the control panel 20 including the selection unit 30 and the display unit 22.

The semi-shielding member 50 does not shield transmission of the light completely, but drops a transmission ratio of the light to below a preset ratio, for an example, below 50%. Therefore, if covered with the semi-shielding member 50, though a shape on a back side of the semi-shielding member 50 is not visible exactly, if an LED or the like illuminates the semi-shielding member 50, making the light to transmit therethrough, the user is made to recognize.

In a case the selection unit is illuminated according to the handling order in the laundry machine in accordance with a preferred embodiment of the present invention, if the semi-shielding member 50 is attached to the front of the control panel 20, making the user to recognize only selection unit illuminated thus through the semi-shielding member 50, the user is unable to recognize not illuminated selection units. At the end, the user can handle only the illuminated selection unit, easily.

The semi-shielding member can be formed of, for an example, a polarization film, or a semi-transparent film. Moreover, it is preferable that the semi-shielding member 50 is formed of an elastic material having predetermined elasticity. That is, in a case the user recognizes the illuminated selection unit and intends to handle the light emission unit, the handling will be made through the semi-shielding member 50. Therefore, it is preferable that the semi-shielding member 50 is elastic enough to transmit a user's handling action to the selection unit.

Moreover, as shown in FIG. 4, the semi-shielding member 50 may be provided with a first opening 52 enough to place the main selection unit 32 therein and a second opening 54 matched to the display unit 22. In this instance, the first opening 52 is required when the main selection unit 32 is of the rotary type which is rotatable, and if the main selection unit is of a general switch type, no opening is required. And, the second opening 54 is formed such that the user can recognize information through the display unit 22, if no display unit 22 is included, no second opening 54 is required.

In the meantime, FIGS. 4 and 5 illustrate laundry machines in accordance with another preferred embodiment of the present invention, respectively.

The laundry machine in FIGS. 4 and 5 enable to supply fine water particles to a space the washing objects are held therein during operation of the laundry machine, preferably, steam, which will be described focused on differences.

Referring to FIGS. 4 and 5, a steam generator 600 may be provided in the cabinet 100 for supplying steam to the drum 400, having a water supply hose 621 and a steam supply pipe 631 connected thereto for supplying the steam to the drum 400.

In general, the water supply hose 621 is connected to a hot water side of a water supply valve 200. It is preferable that the steam supply pipe 631 has a nozzle 631a an en end thereof for making smooth spray of the steam to the drum 400, and mounted such that the end through which the steam is discharged is exposed to an inside of the drum 400. Moreover, though not shown in the drawings, it is preferable that the steam supply pipe 631 is provided with an opening/closing valve for selective spray of the steam. That is, in a case a time period, a time and a number of times of steam spray is controlled by the control panel 120 which will be described later, the control is made possible by opening/closing the valve, selectively. The control panel 120 will be described later in detail.

Moreover, as described before, the laundry machine can have a function for drying the washing objects. For this, in a body 100 of the laundry machine, the laundry machine may include a drying heater 510 for heating air being supplied to the drum 400, and a drying duct 500 which forms a flow passage for supplying hot air into the drum 400, having a fan 520 for forcible blow of the air heated by the drying heater 510 into the drum 400 built therein. In the meantime, the tub 300 has a hot air inlet 310 and a hot air outlet 320 formed therein respectively for introduction/discharge of the hot air heated at the drying heater 510 thereto/therefrom. Such a washing object drying function can be provided to the laundry machine in FIG. 1, too.

In the meantime, the control panel 120 is mounted to a front or a top of the drum type washing machine body 100.

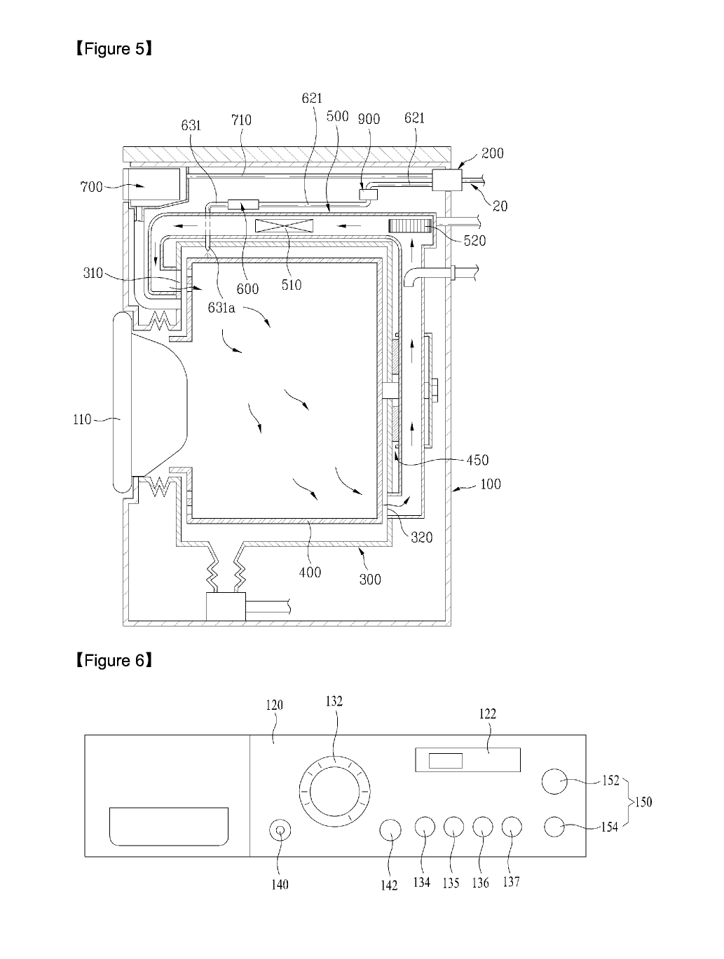

FIG. 6 illustrates a front view of the control panel 120 of the laundry machine in FIGS. 4 and 5.

Referring to FIG. 6, in comparison to the foregoing embodiment, the control panel 120 of the embodiment has a difference in that a steam selection unit 150 is further included thereto which enables to select a steam supply time, or a steam supply amount in a case the steam is supplied to the space having the washing objects held therein. The description will be made focused on the difference.

In the embodiment shown in FIG. 6, the main selection unit 32 includes at least one steam course for supplying the steam, and the sub-selection unit 130 further includes a steam selection unit 150. In this instance, the steam selection unit 150 may include a steam supply time selection unit 152 for selecting a steam supply time, and a steam supply amount selection unit 154 for selecting a steam supply amount.

In the meantime, for an example, in the steam course, there can be a baby clothes course, a barrel sterilizing course, and so on. That is, by washing baby clothes introduced to the laundry machine in the baby clothes course selected thus, the steam is sprayed in a proper time of the washing, rinsing, spinning and drying in default. If the barrel sterilizing course is selected, the steam is sprayed into the drum 400 in a state the laundry is not introduced to the laundry machine, for sterilizing an inside of the drum 400.

It the user selects one of the steam courses with the main selection unit 132, the steam selection unit 150 is illuminated at first, and either rest of the sub-selection units, i.e., the sub-selection units 134, 135, 136, and 137 of the washing step, the rinsing step, and the spinning step or the drying step are illuminated, or the steam selection unit 150 is illuminated finally in succession to the illumination of the sub-selection units, i.e., the sub-selection units 134, 135, 136, and 137 of the washing step, the rinsing step, and the spinning step or the drying step.

The light emission unit of the steam selection unit 150 may be kept emission of the light or may be turned on/off at fixed intervals. It is preferable that she steam selection unit 150 is activated when the steam selection unit 150 is illuminated, and other sub-selection units are kept inactivated in a case the steam selection unit 150 is activated.

In detail, either a steam supply time selection unit 152 and a steam supply amount selection unit 154 of the steam selection unit 150 are illuminated in succession or simultaneously, and the user may handle the selection unit illuminated thus for adjusting a steam supply time, and a steam supply amount.

For an example, if the user adjusts the steam supply amount selection unit 154, a steam spray time period can be adjusted in the steam course. That is, the steam supply amount selection unit 154 can be configured such that, if the user presses the steam supply amount selection unit 154 repeatedly, the steam spray time period can be adjusted to 1 minute, 5 minutes, 10 minutes, or varied with predetermined intervals, i.e., one unit intervals. In this case, as described before, the steam spray time period can be adjusted by adjusting an opening time period of the valve positioned at the steam supply pipe 631. In the meantime, the control unit may further include a steam display unit (not shown) for displaying a steam time selected if the user selects the steam time thus.

If the user adjusts the steam supply time selection unit 152, the steam supply time to be sprayed in the steam course can be adjusted. For an example, if the user presses the steam supply time selection unit 152 repeatedly, the steam supply time can be adjusted, such that the steam is sprayed before water supply, during washing, during rinsing, during spinning and during drying. As described before, it is possible that an opening time of the valve positioned at the steam supply pipe 631 is adjusted to adjust the steam spray time. In a case the steam time is selected thus, a steam time display unit (not shown) can be provided for displaying the steam time selected thus, or the steam spray time can be displayed together with the steam time at the steam display unit.

In the meantime, in the embodiment described with reference to FIGS. 4, 5 and 6 too, alike the laundry machine described before, a semi-shielding member may be provided, which is to be provided to a front of the control panel. Since the semi-shielding member is similar to the foregoing embodiment, no repetitive description will be given.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A laundry machine comprising:
a control panel having a main selection unit for selecting one from a plurality of washing courses, one or more than one sub-selection units for adjusting step conditions in one or more than one course selected by the main selection unit thus, and a plurality of light emission units for illuminating the main selection unit and the sub-selection unit selectively; and
a control unit for driving the laundry machine according to the course and the step conditions selected thus, and controlling to illuminate the main selection unit and the sub-selection units in succession according to a handle order.

2. The laundry machine as claimed in claim 1, wherein the light emission unit includes an LED provided to a back side of each of the main selection unit and the sub-selection units.

3. The laundry machine as claimed in claim 1, wherein the control unit controls the light emission unit for illuminating the main selection unit when the laundry machine is turned on.

4. The laundry machine as claimed in claim 3, wherein, in a case the main selection unit is illuminated, the control unit turns on the light emission unit for a preset time period or turns on/off the light emission unit repeatedly in fixed intervals.

5. The laundry machine as claimed in claim 3, wherein, in a case the main selection unit is illuminated, the control unit activates only the main selection unit while leaving the sub-selection units inactivated.

6. The laundry machine as claimed in claim 3, wherein the control unit controls such that, after the main selection unit is selected, the sub-selection units corresponding to a washing step, a rinsing step, and a spinning step or drying step included to the course selected thus are illuminated according to a handling order.

7. The laundry machine as claimed in claim 6, wherein the light emission unit of the main selection unit is turned off if the sub-selection unit is illuminated.

8. The laundry machine as claimed in claim 6, wherein, if the sub-selection unit is illuminated, the control unit controls such that the light emission unit of the sub-selection unit of which selection is finished is turned off and the light emission unit of the sub-selection unit of the next step is turned on.

9. The laundry machine as claimed in claim 8, wherein the control unit activates only sub-selection unit which is illuminated, while leaving the sub-selection units which are not illuminated inactivated.

10. The laundry machine as claimed in claim 8, wherein, in a case the sub-selection unit is illuminated, the control unit turns on the light emission unit for a preset time period or turns on/off the light emission unit repeatedly in fixed intervals.

11. The laundry machine as claimed in claim 8, wherein, if the sub-selection unit illuminated by the light emission unit is not selected for a preset time period, the control unit turns off the light emission unit and turns on the sub-selection unit of the next step.

12. The laundry machine as claimed in claim 1, wherein the main selection unit includes at least one steam course for supplying steam during operation of the laundry machine, and the sub-selection unit further includes a steam selection unit for controlling at least one condition of the steam supply.

13. The laundry machine as claimed in claim 12, wherein the steam selection unit includes a steam supply time selection unit or a steam supply amount selection unit for controlling a steam supply time or a steam supply amount.

14. The laundry machine as claimed in claim 12, wherein, if the steam course is selected at the main selection unit, the steam selection unit is illuminated at first or last of the illumination of the sub-selection units.

15. The laundry machine as claimed in claim 14, wherein the control unit activates the steam selection unit which is illuminated during illumination of the steam selection unit, and while leaving the sub-selection units which are not illuminated.

16. The laundry machine as claimed in claim 1, further comprising a semi-shielding member for covering at least a portion of a front of the control panel.

17. The laundry machine as claimed in claim 16, wherein the semi-shielding member is provided to cover the main selection unit and the sub-selection unit.

18. The laundry machine as claimed in claim 17, wherein the semi-shielding member is formed of a material having a light transmission ratio which is below a predetermined value to make to recognize the main selection unit or the sub-selection unit which is illuminated.

19. The laundry machine as claimed in claim 18, wherein the semi-shielding member is formed of a polarization film or a semi-transparent film.

20. The laundry machine as claimed in claim 16, wherein the semi-shielding member has a first opening for placing the main selection unit therein and a second opening matched to the display unit of the control panel.

21. A method for controlling a laundry machine comprising the steps of:
illuminating a main selection unit which can select one of a plurality of washing courses; and
illuminating one or more than one sub-selection unit which can change step conditions in one or more than one steps of the course selected at the main selection unit according to a handling order.

22. The method as claimed in claim 21, further comprising the step of turning on the laundry machine before the step of illuminating the main selection unit.

23. The method as claimed in claim 21, wherein, in a case the main selection unit is illuminated, a light emission unit is turned on for a preset time period or turned on/off the light emission unit repeatedly in fixed intervals.

24. The method as claimed in claim 21, wherein, in a case the main selection unit is illuminated in the step of illuminating the main selection unit, only the main selection unit is activated while leaving the sub-selection units inactivated.

25. The method as claimed in claim 21, wherein the step of illuminating one or more than one sub-selection unit includes the step of illuminating the sub-selection unit according to a washing step, a rinsing step, a spinning step or a drying step included to a course selected at the main selection unit.

26. The method as claimed in claim 21, wherein the step of illuminating one or more than one sub-selection unit includes the step of turning off the main selection unit.

27. The method as claimed in claim 21, wherein the step of illuminating one or more than one sub-selection unit includes the step of turning off the sub-selection unit of which selection is finished, and illuminating the sub-selection unit of the next step.

28. The method as claimed in claim 27, wherein only the sub-selection unit which is illuminated is activated, and the sub-selection unit which is not illuminated is inactivated.

29. The method as claimed in claim 26, wherein, in a case the sub-selection unit is illuminated, the light emission unit is turned on for a preset time period or turned on/off repeatedly in fixed intervals.

30. The method as claimed in claim 26, wherein, in a case the sub-selection unit which is illuminated is not selected for a preset time period, the sub-selection unit is turned off and the sub-selection unit of the next step is illuminated.
